(19) United States
(12) Patent Application Publication
(10) Pub. No.: US 2025/0105781 A1
(43) Pub. Date: Mar. 27, 2025

(54) Concentrated Heat and Stored Electricity Fresnel Solar Collector

(71) Applicant: Exowatt, Inc., Miami, FL (US)

(72) Inventors: Hannan PARVIZIAN, Miami, FL (US); Sushrut BAPAT, Miami, FL (US)

(21) Appl. No.: 18/900,292

(22) Filed: Sep. 27, 2024

Related U.S. Application Data
(60) Provisional application No. 63/585,820, filed on Sep. 27, 2023.

(51) Int. Cl. H02S 40/22; F24S 23/30; F24S 40/20; H02S 20/32; H02S 40/10

(52) U.S. Cl. CPC H02S 40/22; F24S 23/31; F24S 40/20; H02S 20/32; H02S 40/10

(57) ABSTRACT

A Fresnel lens panel is used as a solar collector. Different disclosed arrangements simplify or eliminate the need for tracking the sun's position. A self-cleaning coating may be used to keep the Fresnel surface clean.

### CROSS-REFERENCE TO RELATED APPLICATIONS

Benefit is claimed from U.S. application No. 63/585,820 filed Sep. 27, 2023, incorporated herein by reference for all purposes as if expressly set forth.

### FIELD

The technology herein relates to collection of thermal energy, and to solar collectors that collect solar energy and produce electrical and/or thermal output power. More particularly, the technology relates to a Fresnel lens based non-directional thermal collector that does not need to be moved to track the sun's position.

### BACKGROUND & SUMMARY

The energy landscape stands at a pivotal moment, grappling with a triad of challenges: increasing demand, environmental sustainability, and economic viability. Traditional photovoltaic (pV) solar power, although a step in the right direction, is entangled in a web of complications that impede its broader application and effectiveness. One of the most glaring issues is the substantial land footprint required for installations, averaging many acres per megawatt. Coupled with this is the solar power ‘Duck Curve’ dilemma (see e.g., www.energy.gov/eere/articles/confronting-duck-curve-how-address-over-generation-solar-energy) where the supply of solar energy peaks during daytime hours but fails to align with the periods of highest energy demand, typically occurring in the late afternoon and evening. Additionally, the industry is further hampered by material bottlenecks. The sourcing of raw materials like silicon for traditional pV solar panels is increasingly strained, with certain countries holding a near-monopoly in manufacturing and distribution of pV solar cells. This creates a dual problem for many industrialized countries: not only do they lag in global competitiveness in pV solar manufacturing, but they also lack the necessary infrastructure and economies of scale to catch up.

The limitations of current solutions extend beyond just production. Existing solar installations often employ intricate dual-axis tracking systems to optimize for varying sun angles, adding layers of complexity and cost to setups. We all know the times the sun rises and sets are based on the time of year and our location on the earth's surface. For example, days grow shorter in the northern hemisphere as the winter solstice approaches and they grow longer as we approach the summer solstice. Meanwhile, in the southern hemisphere it is just the opposite—as the days are growing longer in the northern hemisphere they are growing shorter in the southern hemisphere and vice versa. Most of us probably vaguely know these changes have something to do with the tilt of the earth relative to the sun which is responsible for changing seasons in the northern and southern hemispheres. Yet, the path the sun takes in the sky is actually more complicated than many of us realize. For example, the exact angle and arc the sun follows on any given day depends on the latitude of the observer and the time of year. Not only is the earth tilted on its axis relative to the sun, but the earth is also orbiting the sun in a path that is elliptical rather than circular. The effects together mean that during the course of a year, if you took the sun's position in the sky at the same time every day you would see that the sun traces an analemma or figure eight in the sky. All this makes for a complex but very predictable path the sun will take across the sky on any given day of the year at any given location on the earth's surface but which will change from one day to the next. See e.g., Siegel, “This Is How The Sun Moves In The Sky Throughout The Year” (Forbes 2019), www.forbes.com/sites/startswithabang/2019/01/01/this-is-how-the-sun-moves-in-the-sky-throughout-the-year/?sh=48c77e7a7303

Many PVT solar panels are stationary and are generally aimed in a direction that will maximize exposure to the sun on most days of the year-that is they are aimed southward for installations in the northern hemisphere. Conventional wisdom is to tilt the solar panels at an angle that corresponds to the latitude at which they are installed-for example, the solar panels should be tilted to 41 degrees for an installation that is 41 degrees latitude north. Tilting stationary panels allows snow to slide off the panels, and may also help to prevent the panels from collecting dirt that might reduce its efficiency.

However, to maximize efficiency, the conventional wisdom is to aim a large or high performance solar collector directly at the sun in order to maximize the energy collected. This is why larger solar collectors are typically designed to track the sun's position. Many such solar collectors track in two degrees of freedom (azimuth and elevation) so they can be aimed at the sun's precise position. Two different actuators (one for azimuth, another for elevation) are often controlled independently to move a solar collector to a precise orientation that aims it at the sun. A computer including a real time clock/calendar can automatically control the position of the collector so it updates its orientation frequently as the sun moves across the sky.

While the theory of automatic solar tracking is straightforward, it can be expensive to provide the necessary mounting structures and actuators to track large heavy solar collection panels. Moreover, requiring solar collectors to be moved/movable imposes additional cost and reliability constraints on connections needed to transport energy collected by the solar collector to storage and/or loads.

When it comes to storing generated energy, the current go-to solutions are electrochemical batteries, predominantly lithium-ion, which are plagued by their own set of problems, including limited material availability and constrained storage capacities. Some have experimented with aluminum or graphite thermal storage but such approaches have not yet been widely adopted.

The urgency of addressing these issues is underlined by multiple factors. Global energy demands are projected to skyrocket by 2050, and the window to mitigate climate change effects is rapidly closing. This sense of urgency is far from theoretical; it has real-world implications for national economics, geopolitics, and environmental stewardship. User interviews with utility providers and energy sector experts confirm the urgency, highlighting the ‘Duck Curve’ as a significant operational obstacle. Extensive case studies and academic literature further validate these concerns, detailing the United States' diminishing role in the global pV manufacturing landscape and identifying untapped solar-rich markets like the Sun Belt.

### BRIEF DESCRIPTION OF THE DRAWINGS

FIGS. 1(A), 1(B) and 1(C) show how a plano-convex lens shape can be deconstructed into a prismatic Fresnel lens surface.

FIG. 1(D) shows how a Fresnel lens can be used to collimate light or focus light.

FIG. 2 shows how a Fresnel lens prismatic surface can be designed to focus on any given collector surface.

FIG. 3 shows correspondence between length and width of a collector surface and the groove direction of a linear groove Fresnel lens.

FIG. 4 shows how the structure of the prisms of a Fresnel lens can effect that focal length of the lens.

FIG. 5 shows how multiple collectors can be disposed on a common surface.

FIG. 6 shows an example Fresnel lens based solar collection system.

FIGS. 7 & 7A show a first solar collector example.

FIGS. 8 & 8A show a second solar collector example.

FIGS. 9 & 9A show a third solar collector example.

FIGS. 10 & 10A show a fourth solar collector example.

FIGS. 11 & 11A show a fifth solar collector example.

FIGS. 12-20 show an example Fresnel lens panel.

### DETAILED DESCRIPTION OF NON-LIMITING EMBODIMENTS

In this challenging environment, the present applicant aims to introduce a sea change through a CHASE (Concentrated Heat and Stored Electricity) technology. This technology is not only easier to set up—eliminating the need for complex dual-axis tracking—but is also crafted from more sustainable raw materials. One of the most compelling facets of CHASE technology is its multifunctional application, truly making it a game-changer in the energy landscape. At its core, CHASE is designed to be modular, allowing for easy deployment in microgrid configurations both domestically and internationally. This modularity extends beyond just energy production—it opens up the door for a range of industrial heat applications, critical in sectors like manufacturing and chemicals. Additionally, CHASE technology presents a robust solution for desalination processes, which is invaluable for regions struggling with water scarcity. Its flexibility is particularly evident in its applicability to disaster relief scenarios. Initially focused on providing immediate power supply, CHASE units are versatile enough to eventually offer heat, clean water, and the impetus to restart local industries. Moreover, each of these applications contributes to the broader goal of decarbonization, providing not just a robust but also a sustainable solution to a host of pressing global challenges.

CHASE technology does not offer just an incremental improvement; its presenting a paradigm shift in how solar energy is produced, stored, and utilized. Its far-reaching implications span from economic growth and energy security to climate change mitigation. Potential markets are global, ranging from Central America to the Middle East. The advent of CHASE technology marks not just an innovation but a necessary evolution for the solar energy sector.

In example embodiments, each module is capable of producing 1 kWh of electric power consistently over a 24-hour period and does so at low cost that is significantly more cost-effective than existing solutions. Furthermore, because of their compact size—each module occupying a space of only 10 cubic feet as one example—they are exceptionally scalable. This stands in stark contrast to other solar technologies, such as Concentrated Solar Power (CSP), where a 100 MW plant can take up to 10 years to become operational. With CHASE technology, that lead time is reduced to a matter of months.

One example non-limiting embodiment of CHASE uses a Fresnel lens to collect solar energy. As explained below, the Fresnel lens can in some embodiments be stationary, thereby avoiding the complexity of providing one or two dimensional tracking of the lens.

### Use of Fresnel Lenses For Solar Collection

In the early 19th Century, a French scientist named Augustin-Jean Fresnel (pronounced “Frennel”) who had devoted his career to studying the wave properties of light was asked by the French government to solve a problem—how to make it easier for mariners to see lighthouses from greater distances out at sea. At that time, lighthouses were lit by kerosine lamps that did not produce much light. Lenses were often used to focus the light into beams, but the lenses were very thick and resulted in substantial light loss. Instead of trying to figure out how to make the lamps more powerful, Fresnel started doing experiments on thinner optical systems that could beam the light from the kerosine lamp in the direction of ships out at sea.

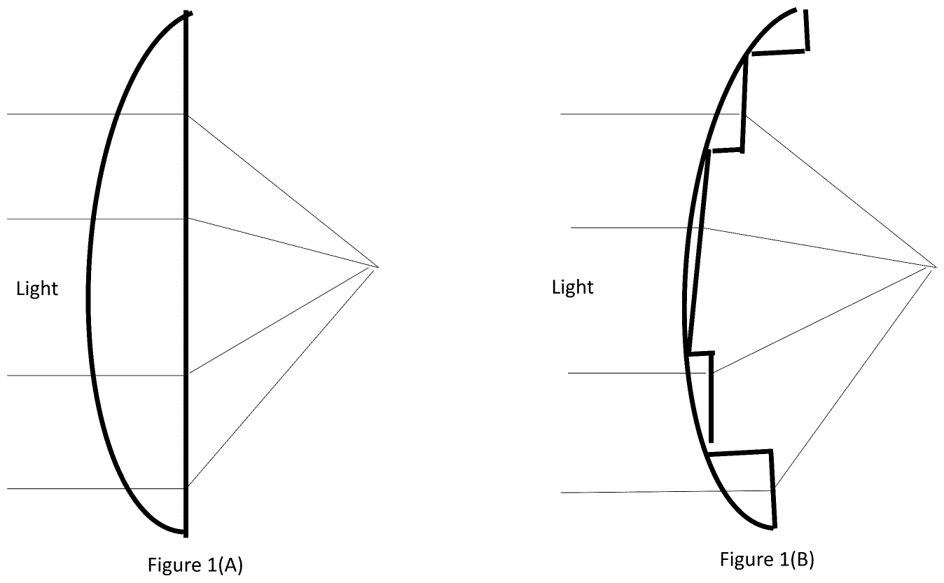

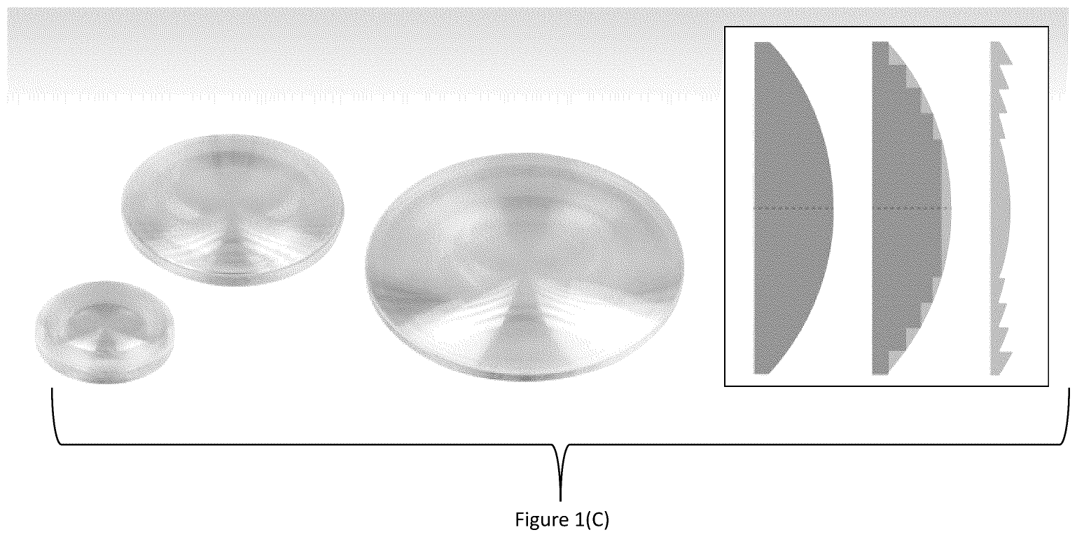

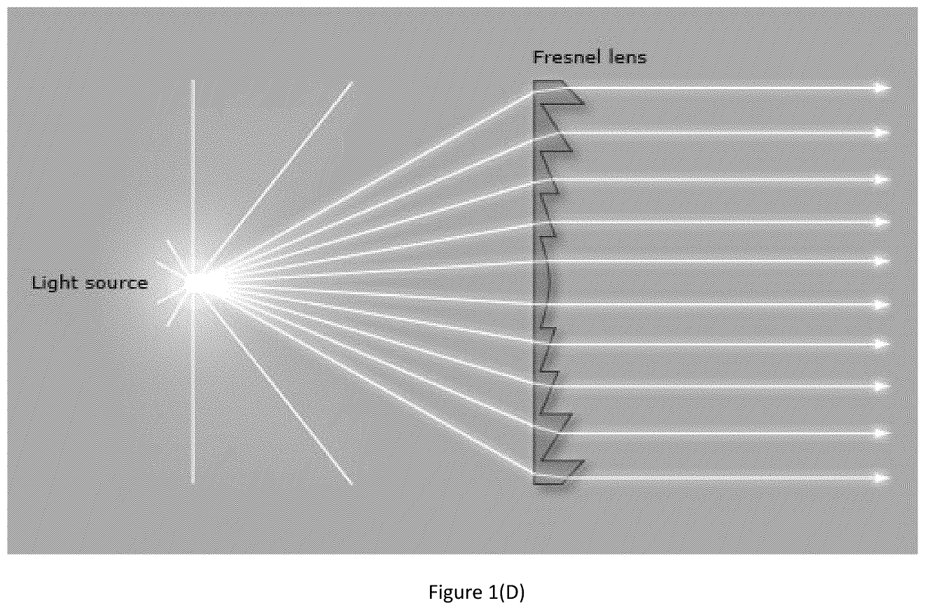

Fresnel had studied the properties of a conventional plano-convex lens (one side planar, the other size convex—see FIG. 1(A), 1(C)) used to focus light, and knew that the lens' refraction or light bending effects were caused by different light rays (wavefronts) passing through different thicknesses of glass on their paths to/from the curved convex surface of the lens. Fresnel thought about how to decrease the amount of glass the light had to pass through in order to reach that curved convex surface. Fresnel's insight was that the same light bending and focusing effects could be obtained if the “center” thickness of the lens was simply left out and the lens was instead deconstructed into a series of prism-shaped rings each mimicking a portion of the curved concave surface of the plano-convex lens (see FIG. 1(B), 1(C)). Fresnel applied this principle to collimate the light from the lighthouse's kerosine lamp into a light beam of parallel light rays (see FIG. 1(D). His lens idea revolutionized lighthouses at the time by reducing the light loss through the optical system and thus substantially increasing the distance from which mariners could see the light from an existing kerosine lamp.

Fresnel lens remain in common use today for all sorts of applications including handheld plastic magnifying glasses, illumination systems, computer displays, photography, projection systems and more. An advantage of Fresnel lenses is that they can be constructed by etching, stamping or molding grooves in a planar (flat) sheet of large dimensions comprising a durable material such as acrylic or polycarbonate plastic. Due to the availability of Fresnel lenses in large sizes, they are an ideal choice for focusing sunlight to heat a sample placed at the focal point of the lens. They are also commonly used to collect light for solar heat collectors. See e.g., Xie, “Concentrated solar energy applications using Fresnel lenses: A review”, Renewable and Sustainable Energy Reviews, Volume 15, Issue 6, August 2011, Pages 2588-2606 doi.org/10.1016/j.rser.2011.03.031. Aspherical Fresnel lenses may provide a better light concentrating ability than spherical Fresnel lenses. See e.g., Edmund Scientific Optics, “Fresnel Lens Review” (2012) youtu.be/pNOGMfmti4w?si=1pTZST_ALEVSdz6Z. However, there are still significant challenges to using Fresnel lenses successfully for solar collection. In particular, the conventional wisdom is that Fresnel lens operate efficiently only if the light source is directed normal to the Fresnel prismatic surface, and that off-axis light sources are not magnified efficiently. Since the sun constantly moves across in arc in the sky, the conventional wisdom is thus that the orientation of the Fresnel lens must be tracked in two orthogonal axes to the position of the sun. Fresnel lenses can comprise very large sheets of thin material such as acrylic or polycarbonate. They need to be adequately supported (e.g., in frames) to prevent damage and then efficiently tracked/moved with motion of the sun. This is theoretically straightforward but expensive and complicated as a practical matter. Further innovation is therefore desirable.

Example embodiments herein provide Fresnel lens based solar collectors where the lens is not moved to track the changing position of the sun. In one embodiment, a collector optically coupled to a Fresnel lens is configured to collect thermal or solar energy from a focal point of the lens that moves in a predictable way in-plane such as in a straight line with movement of the sun. In another example arrangement, an additional lens such as a pyramid lens is used to refract/focus light rays from the sun onto a stationary Fresnel lens. Such arrangements may thus provide a stationary Fresnel lens that can capture light from a wide variety of different angles and focus the light onto a single focal point. Another embodiment provide an arrangement including a movable absorber that tracks the moving focal point of a stationary Fresnel lens. A further example arrangement comprises a combination of lenses one of which may be a Fresnel lens, that together provide a constant focal point onto a stationary absorber. Yet another arrangement comprises a combination of an in-plane tracking lens and a moving or stationary absorber that tracks the moving focal point from the lens as the sun's sky position changes.

### Example Embodiments

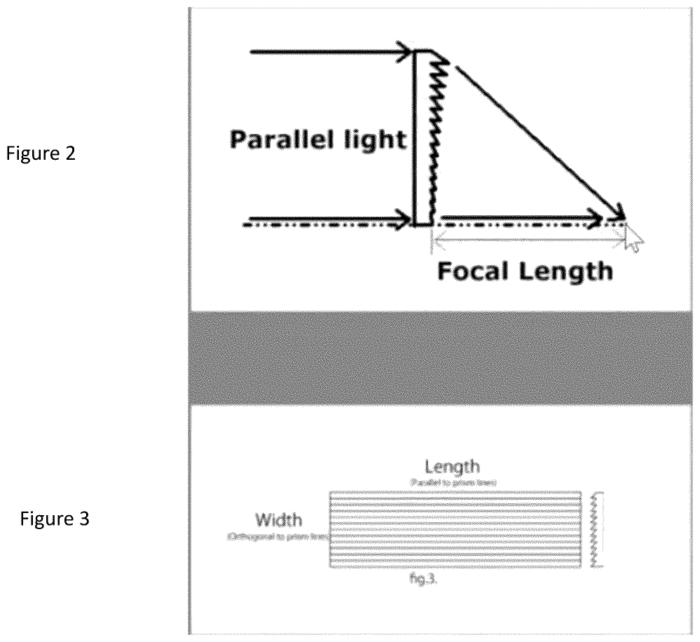

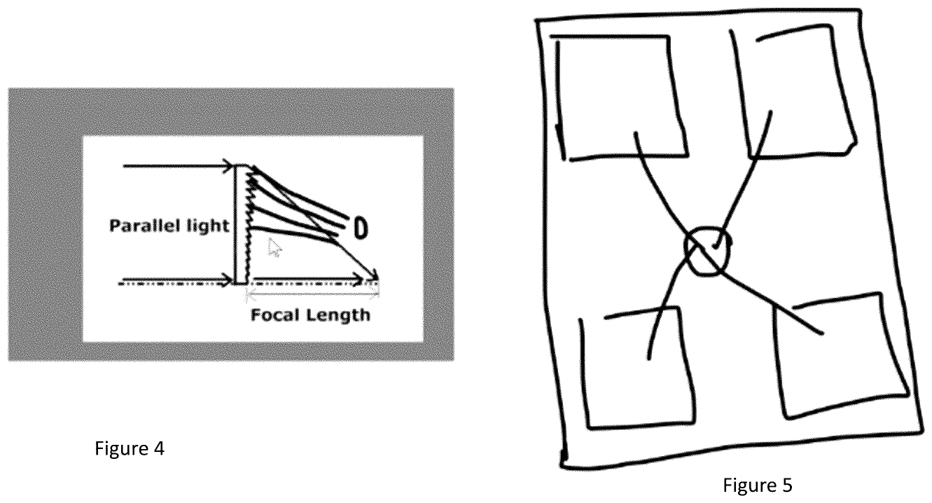

FIG. 2 shows an example Fresnel lens used to focus light on a collector, where the focal length of the Fresnel lens corresponds to the length of the collector. In the example embodiment shown, parallel light rays from the sun striking different parts of the Fresnel prismatic surface are refracted by different amounts by the linear grooves of the prismatic surface so they all strike the collector surface. As FIG. 3 shows, the length of the collector is parallel to the linear groove lines of the Fresnel lens prismatic surface and the width of the collector is orthogonal to the linear lines of the Fresnel lens prismatic surface. The collector is thus dimensioned to have a width that is equal to a dimension of the Fresnel lens across the groove lines, and a length that depends on the prism structures, i.e., the spacing between the groove lines and the angles of the prism surfaces the groove lines form. The Fresnel lens may thus be designed and fabricated to illuminate any desired dimension of collector surface, e.g., to provide high efficiency collection without overheating the collector. See FIG. 4 for example which shows how changing the angles and/or spacing of the grooves forming the prismatic surface of the Fresnel lens can spread the light beams across a longer or shorter collector surface.

In some embodiments, the Fresnel lens can be made stationary and the collector can be moved to track the focal point of the Fresnel lens as the angle of incidence of the sun's rays on the Fresnel lens changes with changing position of the sun. The tracking problem thus changes from tracking the position of the sun to tracking the position of a lens focal point within the plane of the collector—which can provide substantially simplified mechanical tracking mechanisms. For example, in one embodiment, the collector provides large planar collection area so the Fresnel lens focal point remains on the surface of the collector as the sun moves relative to the Fresnel lens. Thus, in some embodiments, instead of moving the Fresnel lens to track the sun's position and keep the focal point of the lens at a fixed point on the collector, the arrangement allows the lens' focal point to move as the sun's position changes—and the collector is configured to capture the moving focal point. The Fresnel lens is still able to focus the sun's rays efficiently even when the angle of incidence onto the lens is not close to normal incidence to the surface of the Fresnel lens—but the focal point of the lens is allowed to change.

A collector is designed to collect energy from this variable-position focal point—by moving the collector, constructing the collector to be large enough to capture the focal point, or both. Instead of collecting from a lens fixed focal point, the collector may thus be configured and properly spaced from the Fresnel lens to collect from a variable-position focal point that changes within a range determined by among other things the time of year and the geographic latitude on the earth's surface at which the collector is installed. Because the angle of incidence onto the collector of the light beam refracted by the lens does not matter, the collector can be tracked by simply changing its position within a plane—there is no need in some embodiments to change its orientation. This substantially simplifies the tracking mechanisms required. In such embodiments, the polar coordinates of the sun's position relative to the collection system (which may require wide-angle tracking from 0-90 degrees in elevation and 90 degrees to 270 degrees in azimuth) are translated into simple XY linear positions within the collector plane, since what is now being tracked is not the arc of the sun's travel but rather the projection of the sun's position along that arc onto the plane of the collector surface. In such designs, the lens does not need to move at all, either because of the design of the lens or because of the way the absorber tracks the focal point of the lens, or both.

FIG. 4 also demonstrates that a Fresnel lens can be designed to have higher transmissivity efficiency to off-axis light rays, i.e., light rays that are not exactly normal to the planar surface of the Fresnel lens. For background see for example Alleyne, “Determination Of Off-Axis Diffraction Efficiency For Fresnel Microlenses Using Rigorous Coupled Wave Analysis” Photonics Systems Group McGill University, Montreal (November 2003). For example, an additional lens such as a pyramid lens (see below) can be used to provide additional refraction onto the Fresnel lens for off-axis positions of the sun. This off-axis characteristic is useful in embodiments where the Fresnel lens is not mechanically moved to track the sun's position but instead remains stationary or is otherwise responsible for refracting light striking it along an axis other than normal to the Fresnel lens prismatic surface.

In some embodiments, the Fresnel lens surface may be coated with a self-cleaning coating to make it easier to keep the lenses clean. See e.g., Zhou et al, “Superhydrophobic self-cleaning antireflective coatings on Fresnel lenses by integrating hydrophilic solid and hydrophobic hollow silica nanoparticles”, RSC Advances Issue 44 (2013); Adak et al, “Sol-gel processed silica based highly transparent self-cleaning coatings for solar glass covers”, Materials Today Proceedings, Volume 33, Part 6, 2020, Pages 2429-2433, doi.org/10.1016/j.matpr.2020.01.331.

FIG. 5 shows multiple collectors disposed on a common panel or other surface and the outputs of such multiple collectors being combined to provide a common heat source supply. For example, the FIG. 5 multi-collector panel can be used to receive light focused by four respective Fresnel lens panels. Such multi-collector panel can be used to load balance the outputs of plural Fresnel lens panel collectors.

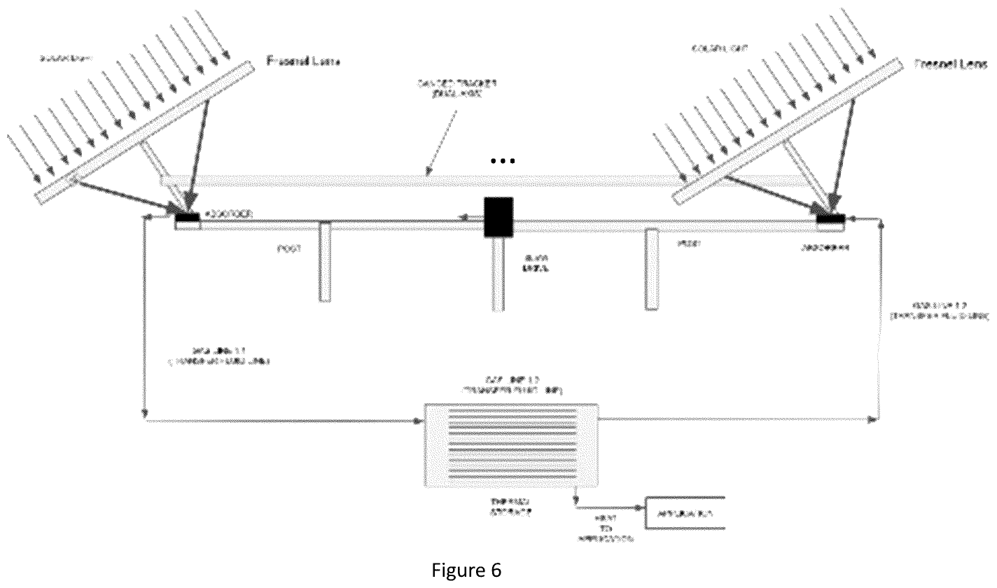

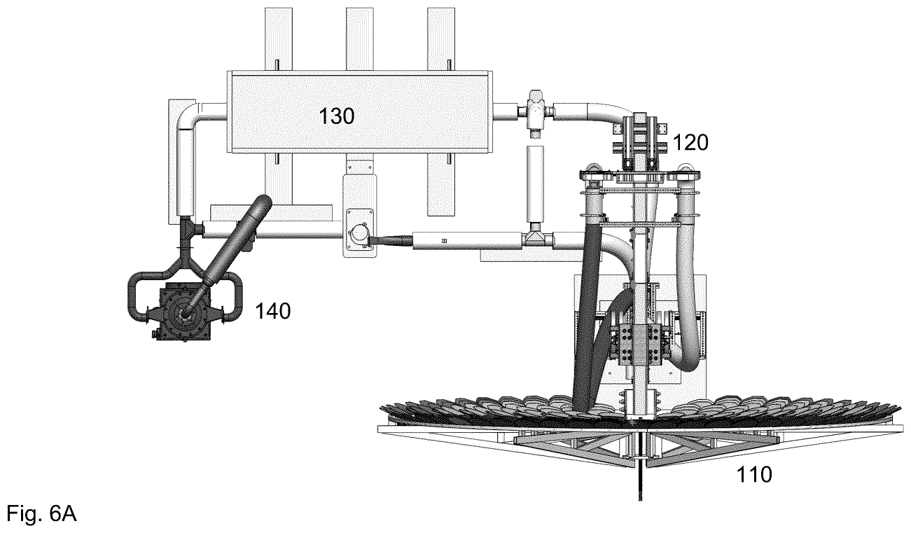

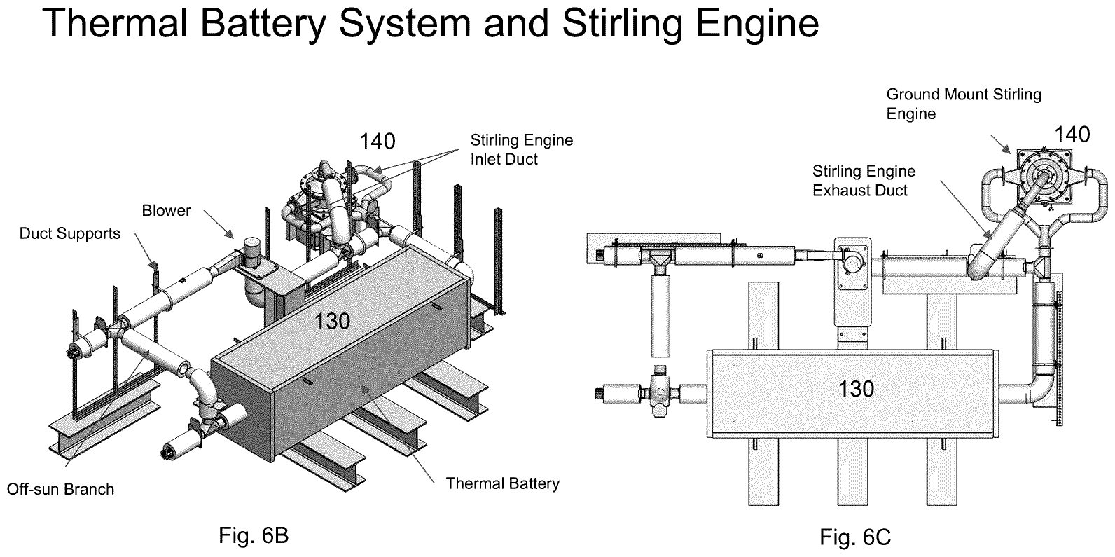

FIG. 6 shows an example Fresnel lens based solar collection system. In the example shown, any number of planer Fresnel lenses 1-N are aimed at the sun. Each Fresnel lens focuses light on a respective collector. The collectors may be coupled together with a heat circulating system to transport the collected heat to a thermal storage or other load such as a stirling engine that converts the collected heat to electricity. This system has the advantages that the components are easy to mass produce, the inexpensive Fresnel Lens are modular and mass producible, a Stationary Transport tunnel is used, the system provides easy ground Maintenance, the system is configurable to have either dual axis or single axis tracking, N number of modules can be added in Series or parallel to increase temperature and energy, the lenses can be stowed at or near the ground level, and a gas or fluid transport medium can be used.

The Fresnel lens may but need not be planar. For example, the Fresnel lens can be curved in one or two dimensions. Similarly, the collector can be in any desired shape and need not be planar.

FIGS. 6A-6C show more details of thermal equipment that may be coupled to the Fresnel lens based collector. A thermal battery 130 and/or a stirling thermal engine 140 may receive thermal energy via ducts and blowers (the thermal carrying medium may be a gas such as air or CO2). Such a duct/blower system can recirculate the heated medium so additional heat can be extracted from the medium on additional passes through the system.

### Example I

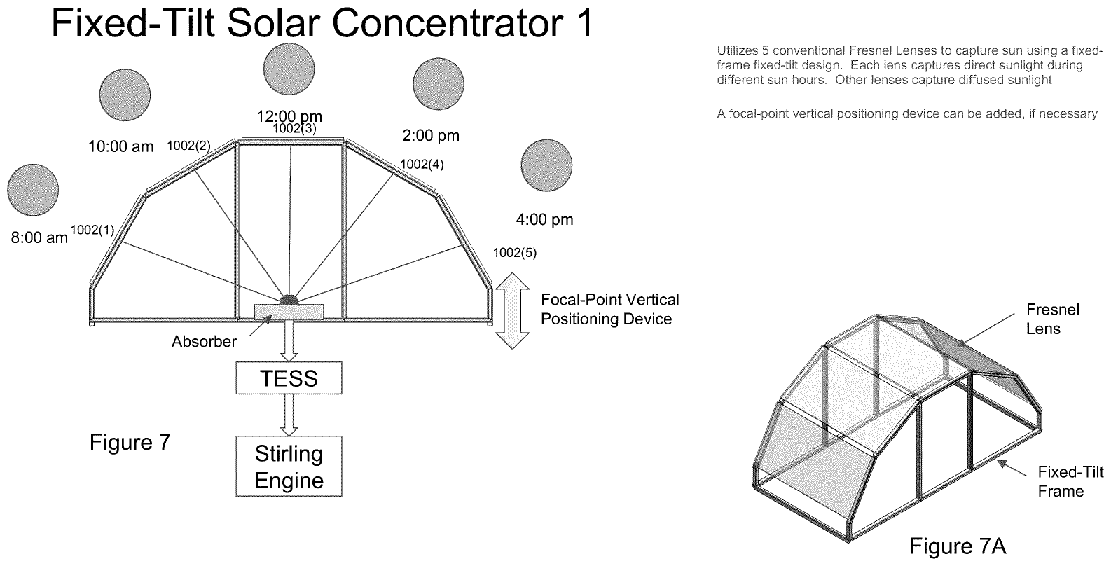

The FIGS. 7 & 7A example utilizes five (5) conventional planar Fresnel lens panels to capture solar energy from the sun using a fixed-frame fixed-tilt design. In the example shown, each lens panel captures direct sunlight during some period of daylight hours. However, the lens panels are oriented differently so they capture direct sunlight during different sun hours. No movement of the light incident surface 2004 or the absorber is necessary or required.

In the example shown, the lens panels 1002 are mounted to a common frame that holds the lens panels in their respective fixed tilt orientations relative to the sun and one another. In the example shown, the lens panels are mounted adjacent to one another to provide a series or sequence of progressively tilted light focusing panels. For example, lens panel 1002(1) is oriented/tilted at an angle such as +30 degrees from vertical to capture direct sunlight when the sun illuminates it during the period from 7 am to 9 am, lens panel 1002(2) is oriented/titled at an angle such as +60 degrees from vertical to capture direct sunlight when the sun illuminates it during the period from 9 am to 11 am, lens panel 1002(3) is oriented/tilted at an angle such as 90 degrees from vertical to capture direct sunlight when the sun illuminates it during the period from 11 am to 1 pm, lens panel 1002(4) is oriented/titled at an angle such as −60 degrees from vertical to capture direct sunlight when the sun illuminates it from 1 pm until 3 pm, and lens panel 1002(5) is oriented/titled at an angle such as −30 degrees from vertical to capture direct sunlight when the sun illuminates it from 3 pm to 5 pm. The length of time during which a given lens panel is illuminated to capture direct sunlight and thus the number of panels used in the collecting structure to continuously capture the sun's solar energy may depend on the lens panel's field of view (FOV) and focal length.

In this embodiment, each lens contributes to the absorbed energy whenever the sun is in the sky. However, the greater the angle a normal to a given lens is to the direction to the sun, the less that lens will contribute to energy being captured by the absorber. The situation changes continually as sun changes position in the sky. While a particular lens is illuminated to capture direct sunlight, other (e.g., adjacent) lenses are illuminated to capture more diffuse sunlight, i.e., captured non-direct rays.

In the example shown, each panel 1002 focuses captured light onto the same absorber focal point 1004. However, in other embodiments, different absorbers could potentially be used for different lens panels. The absorber can be coupled to a thermal load such as a thermal storage, a thermal engine, a building or facility heating system, or any other load requiring thermal energy. A focal-point vertical positioning device can be added, if necessary or desired, to change the position of the absorber to adjust for the focal length of the particular lens providing a dominant amount of focused solar energy at a given time. The FIG. 7A structure is typically oriented to maximize incident direct sunlight onto the panels 1002 for different seasons, based on latitude.

### Example II

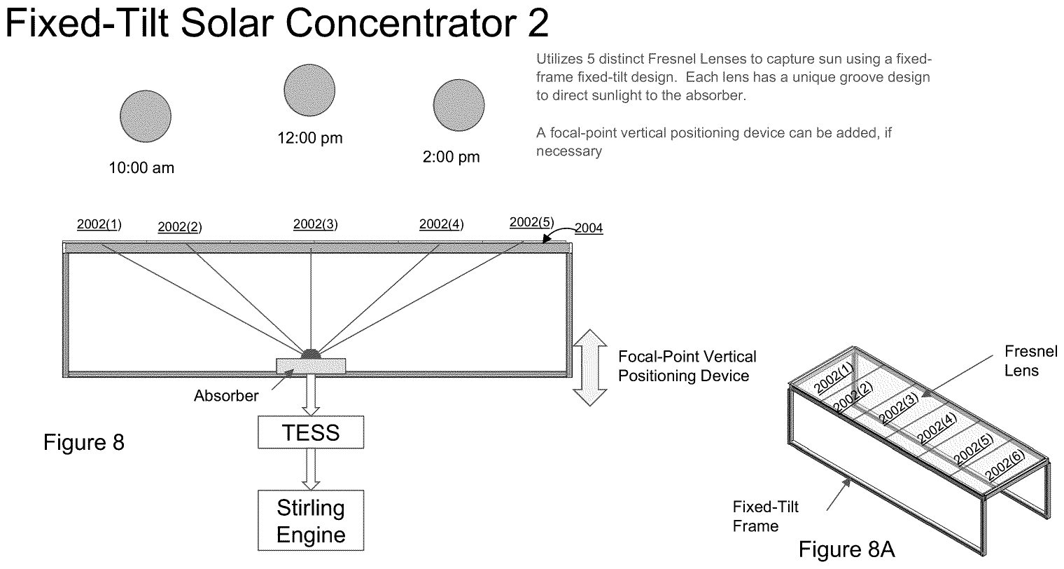

The embodiment shown in FIGS. 8 & 8A defines a light incident surface 2004, which may but need not be planar, of a lens structure. The light incident surface has different refractive indices at different portions of the surface. These refractive indices are disposed relative to different sky positions of the sun at the latitude where the collector structure is installed. As can be seen in FIG. 8, as the sun changes its position in the sky, the light incident surface 2004 applies an appropriate refractive index to refract and focus the light onto the absorber. No movement of the light incident surface 2004 or the absorber is necessary or required.

The particular embodiment shown in FIGS. 8 & 8A utilizes five (5) or six (6) distinct Fresnel Lens panels 2002 to capture sun using a fixed-frame fixed-tilt design. Each lens panel 2002 has a unique (different) groove design to direct sunlight to the absorber. Specifically, the central panel 2002(3) (or central portion of light incident surface 2004) has Fresnel lens grooves that direct and focus directly-downward incident light directly downwards onto the absorber. Panels 2002(2), 2002(4) adjacent to each side of central panel 2002(3) have angled Fresnel lens grooves that direct and focus off-normal-incident light toward the absorber. Similarly, panels 2002(1), 2002(5) adjacent to panels 2002(2), 2002(4), respectively, have further angled Fresnel lens grooves that direct and focus off-normal-incident light toward the absorber. As the sun changes its position in the sky, rays from the sun strike the light incident surface 2004 at a changing series of angles and are accordingly directed and focused onto the absorber by appropriately-angled Fresnel grooves.

A focal-point vertical positioning device can be added, if necessary or desirable. However, in other embodiments, different absorbers could potentially be used for different lens panels. The absorber can be coupled to a thermal load such as a thermal storage, a thermal engine, a building or facility heating system, or any other load requiring thermal energy. A focal-point vertical positioning device can be added, if necessary or desired, to change the position of the absorber to adjust for the focal length of the particular lens providing a dominant amount of focused solar energy at a given time. The FIG. 8A structure is typically oriented to maximize incident direct sunlight onto the panels 2002 for different seasons, based on latitude.

### Example III

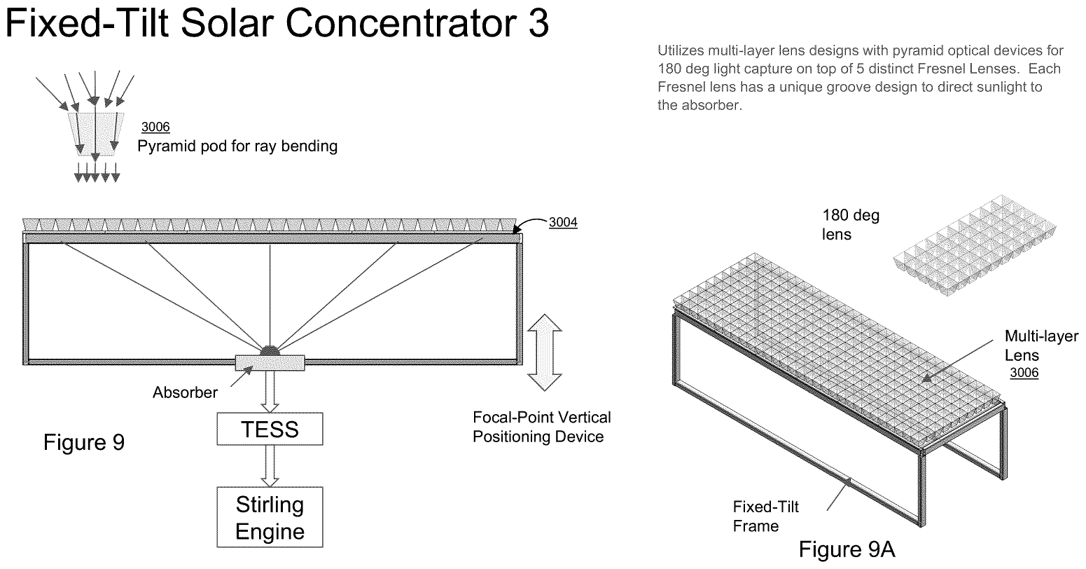

FIGS. 9 & 9A show an embodiment that utilizes multi-layer lens designs with pyramid optical devices for 180 degree light capture on top of one or a plurality (e.g., 5) distinct Fresnel Lenses. Each Fresnel lens has a unique groove design to direct sunlight to the absorber. In more detail, the light incident surface 3004 in one embodiment can be the same as shown in FIGS. 8 & 8A, defining differently angled Fresnel grooves. An additional layer of pyramid lenses catch light from any angle and refract it towards the light incident surface 3004 beneath to boost solar cell efficiency. See Vaidya et al, “Immersion graded index optics: theory, design, and prototypes,” Microsyst Nanoeng 8, 69 (2022). doi.org/10.1038/s41378-022-00377-z. The pyramid lenses refract or bend the light rays from the sun so they rays are concentrated at the same position on the light incident surface, even as the suns changes position so that the light rays change direction. The Fresnel lens grooves defined by the structure of the optical panel providing the light incident surface 3004 then further refract the now normal-incident light toward the absorber—with different portions of the light incident surface providing different degrees of refraction based on the position of the portion on the panel. Thus, many bundles of light rays captured by many different pyramid lenses are directed to the same focal point on the absorber to provide extremely intense illumination for solar energy collection.

The absorber can be coupled to a thermal load such as a thermal storage, a thermal engine, a building or facility heating system, or any other load requiring thermal energy. A focal-point vertical positioning device can be added, if necessary or desirable, to change the position of the absorber to adjust for focal length. In other embodiments, different absorbers could potentially be used for different lens panels. The FIG. 9A structure is typically oriented to maximize incident direct sunlight onto the panels 2002 for different seasons, based on latitude.

### Example IV

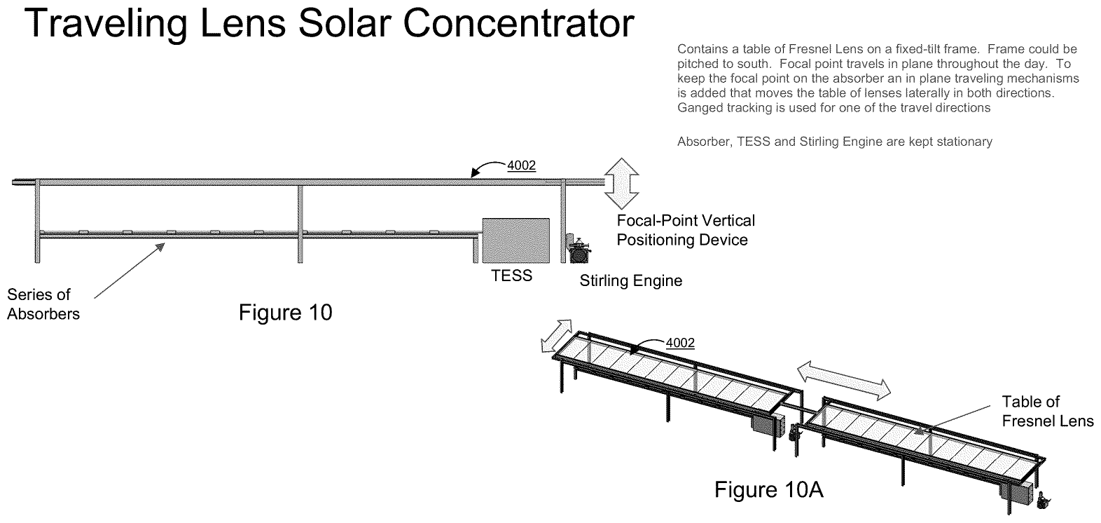

FIGS. 10 & 10A show an example embodiment of a Traveling Lens Solar Concentrator. This example embodiment comprises or contains a table of Fresnel Lenses 4002 on a fixed-tilt frame. The frame could be pitched to south. The focal point travels in plane throughout the day as the sun traces an arc in the sky. To keep the focal point on the absorber, an in plane traveling mechanisms moves the table of lenses 4002 laterally in both directions as shown in FIG. 10A. Such movement in two directions does not change the orientation/tilt of the lens table 4002—which remains constant. Rather, it simply moves the position of the focal point so it remains on the absorber. Ganged tracking may be used for one of the travel directions so multiple lens tables can be moved at the same time by the same amount by the same actuator. The absorber, TESS and Stirling Engine are kept stationary in this embodiment, which can have advantages in terms of connections between the absorber and the thermal load(s). As above, the absorber vertical position can be adjusted to adjust the focal length of the collector.

### Example V

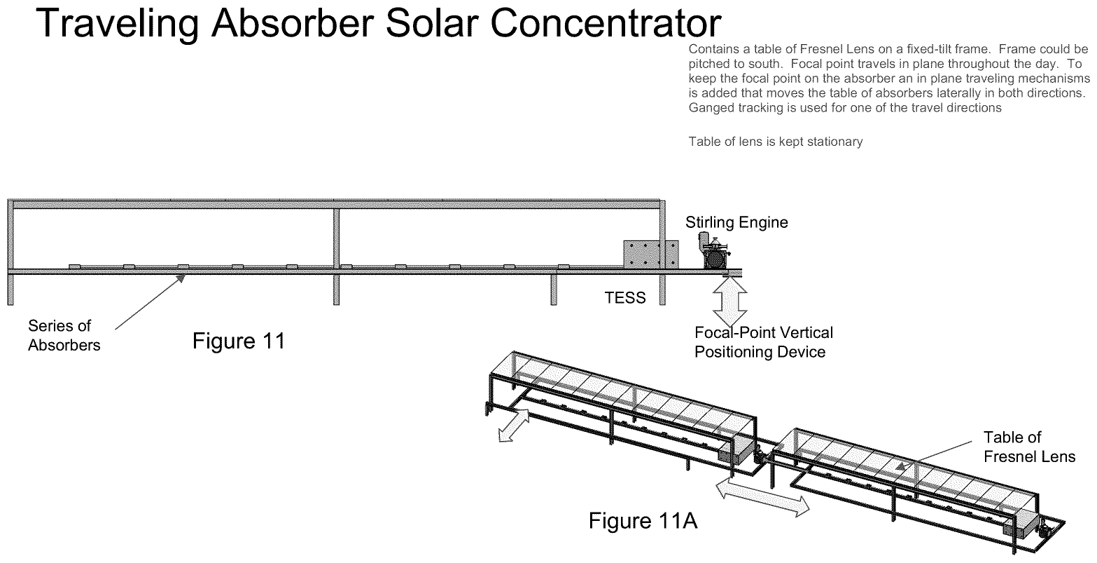

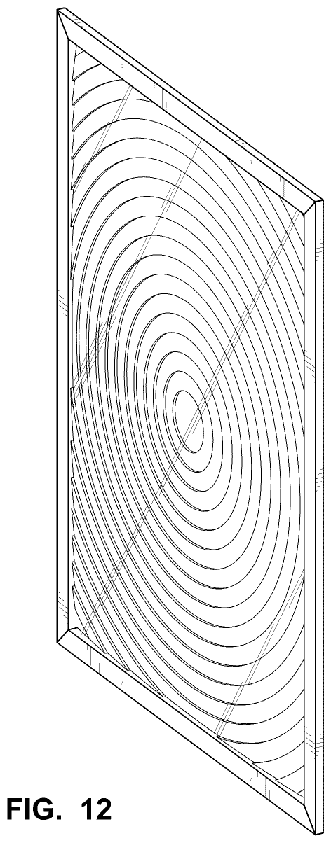

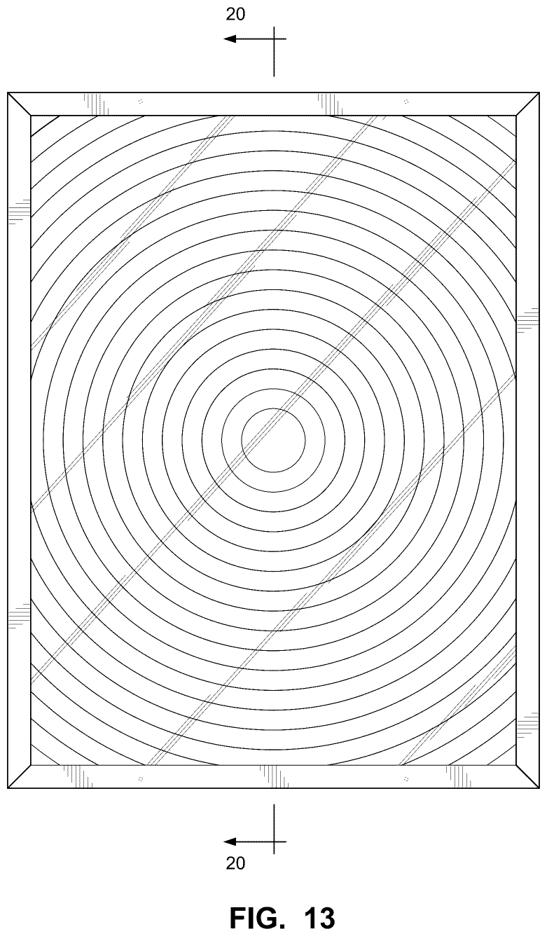

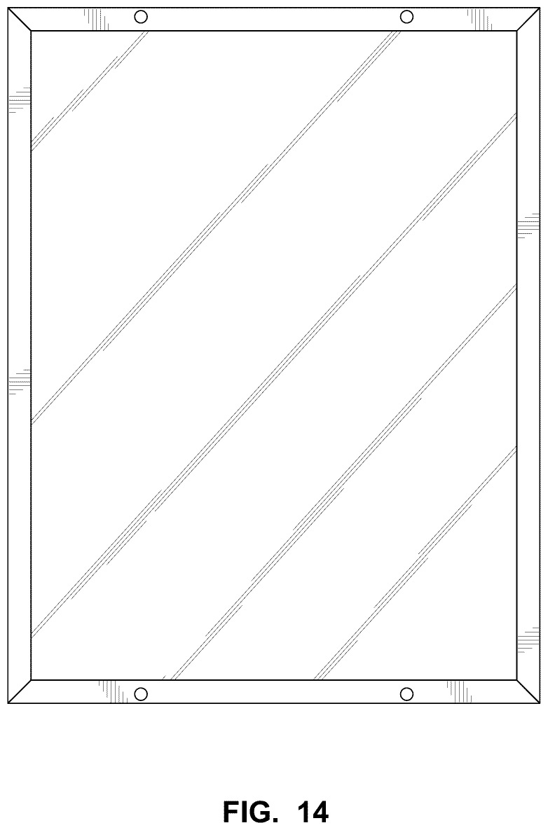

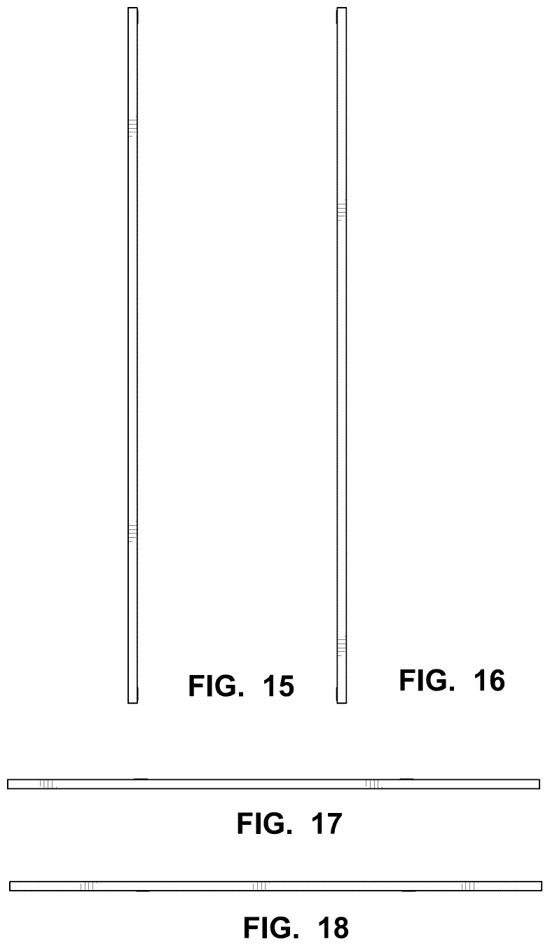

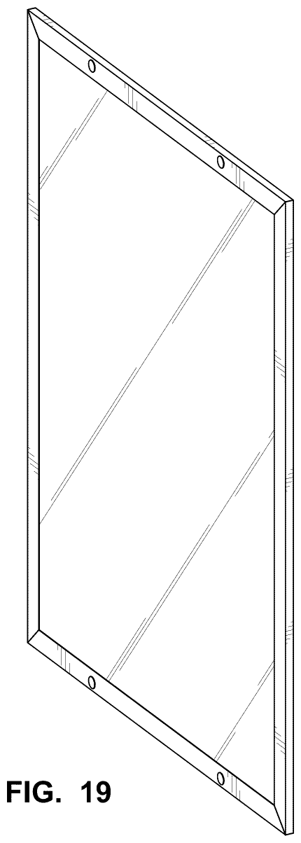

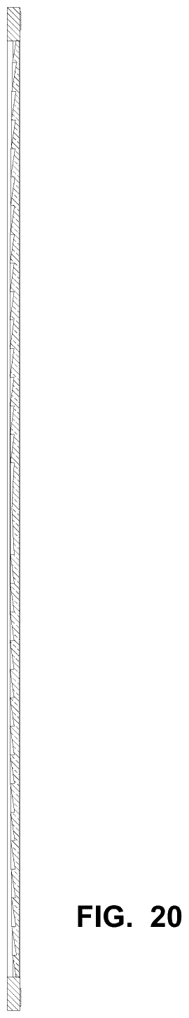

In another embodiment shown in FIGS. 11 & 11A, the absorber is moved in-plane in two directions and the lens table 4002 remains stationary. The absorber position is changed in-plane in two dimensions to keep the lens table focal point on the absorber surface as the sun's position changes in the sky. As above, the absorber vertical position can be adjusted to adjust the focal length of the collector.

### Example VI

FIG. 12 and following show different views of an example Fresnel lens panel suitable for use in any of the above embodiments.

All patents and publications cited herein are incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A solar collector comprising:
a Fresnel lens array comprising at least a first Fresnel lens and a second Fresnel lens; and
an absorber optically coupled to the Fresnel lens array,
wherein the absorber is disposed and configured receive focused sunlight from different ones of the at least first Fresnel lens and second Fresnel lens depending on position of the sun relative to the Fresnel lens array.

2. The solar collector of claim 1 wherein the solar collector has no moving parts.

3. The solar collector of claim 1 wherein the first Fresnel lens has a different tilt as compared to the second Fresnel lens.

4. The solar collector of claim 1 wherein the first Fresnel lens and the second Fresnel lens have the same orientation.

5. The solar collector of claim 1 wherein the first Fresnel lens and second Fresnel lens are self-cleaning.
